(19) United States
(12) Patent Application Publication
(10) Pub. No.: US 2026/0213408 A1
(43) Pub. Date: Jul. 23, 2026

(54) A PHASE-RECONFIGURABLE VIRTUAL SURFACE REFLECTARRAY BY MEANS OF A PROGRESSIVE TIME DELAY ELEMENT RESPONSE

(71) Applicant: Massachusetts Institute of Technology, Cambridge, MA (US)

(72) Inventors: Michael Thomas Craton, Watertown, MA (US); David W. Browne, Glendale, CA (US)

(21) Appl. No.: 18/658,626

(22) Filed: May 8, 2024

Related U.S. Application Data
(60) Provisional application No. 63/503,928, filed on May 23, 2023.

(51) Int. Cl. H01Q 3/46; H04B 7/04; H04B 7/06

(52) U.S. Cl. CPC H01Q 3/46; H04B 7/04013; H04B 7/0617

(57) ABSTRACT

A phase-reconfigurable reflectarray or reconfigurable intelligent surface (RIS) is disclosed. The reflectarray or RIS includes a plurality of reflectors, wherein each reflector includes an antenna element in communication with a microwave circuit. The microwave circuit includes a fixed time delay element and an electronically controllable phase shifter. The time delay associated with each reflector is fixed, but the time delays vary across the reflectarray. In this way, the fixed time delay elements create a virtual surface, which may be any desired shape, such as a parabolic reflector, a spherical reflector, hyperbolic reflector, or a parabolic cylinder. Additionally, the reflectarray employs a beamforming algorithm to control the phase introduced by each phase shifter so as to maximize the desired signal and suppress interfering signals.

This application claims priority to U.S. Provisional Patent Application Ser. No. 63/503,928, filed May 23, 2023, the disclosure of which is incorporated herein by reference in its entirety.

This invention was made with government support under FA8702-15-D-0001 awarded by the U.S. Air Force. The government has certain rights in the invention.

### BACKGROUND

Reflectarrays, in particular reconfigurable reflectarrays, and the closely related technology of Reconfigurable Intelligent Surfaces (RIS), are expected to be critical technologies enabling the deployment of 5G and 6G+ technology, as well as enabling technologies for next-generation satellite communications, sensing, automotive radar, and Internet of Things (IoT) applications. Collectively, these emerging and rapidly growing application spaces represent many billions of dollars of investment across several industries. For this broad set of applications, it is desirable to be able to operate in the presence of interfering signals and to steer or place beams and nulls in particular directions. This may be accomplished using a conventional phased-array antenna where all or many elements of an array of individual antennas have a physically connected radio (transmit and/or receive chain) and all elements have some electronically controllable phase shifting capability. This conventional solution to address these issues is significantly more expensive to build and design than a reconfigurable reflectarray, which is inherently lower cost, and is more easily scalable to offer a typically much larger number of degrees of freedom for beamforming than a conventional phased array.

However, a well-known shortcoming of the class of technology encompassing reconfigurable reflectarrays and RIS is the bandwidth limitation. The array bandwidth is the frequency band over which the array's beam pattern is constant. More importantly, for some applications, this array bandwidth, which is also referred to as simply “bandwidth”, is determined by the band over which the nulls in the beam pattern are maintained at a constant direction.

Therefore, it would be beneficial if there was a system that could expand the usable array bandwidth of reconfigurable reflectarrays (and RIS) in the presence of interference, in particular the nulling bandwidth and beam squint. Further, it would be advantageous if the usable bandwidth was expanded by orders of magnitude.

### SUMMARY

A phase-reconfigurable reflectarray or reconfigurable intelligent surface (RIS) is disclosed. The reflectarray or RIS includes a plurality of reflectors, wherein each reflector includes an antenna element in communication with a microwave circuit. The microwave circuit includes a fixed time delay element and an electronically controllable phase shifter. The time delay associated with each reflector is fixed, but the time delays vary across the reflectarray. In this way, the fixed time delay elements create a virtual surface, which may be any desired shape, such as a parabolic reflector, a spherical reflector, hyperbolic reflector, or a parabolic cylinder. Additionally, the reflectarray employs a beamforming algorithm to control the phase introduced by each phase shifter so as to maximize the desired signal and suppress interfering signals.

According to one embodiment, a phase-reconfigurable reflectarray or reconfigurable intelligent surface (RIS) is disclosed. The phase-reconfigurable reflectarray or RIS comprises a plurality of phase-reconfigurable reflectarray elements to transmit or receive radio signals disposed on a planar surface; wherein each phase-reconfigurable reflectarray element comprises: an antenna element that feeds a microwave circuit; wherein the microwave circuit comprises a fixed time delay element in series with an electronically controllable phase shifter. In some embodiments, the fixed time delay element is fixed for each reflectarray element and is variable across the phase-reconfigurable reflectarray or RIS. In certain embodiments, a delay of the fixed time delay element is determined based on a spatial position of the reflectarray element in the phase-reconfigurable reflectarray. In certain embodiments, the delay ranges from 0 to twenty phase wraps of a center frequency. In some embodiments, the fixed time delay element is formed from a slow wave transmission line. In some embodiments, a delay associated with each fixed time delay element is configured to create a virtual surface. In certain embodiments, the virtual surface comprises a parabolic reflector. In some embodiments, a feeding antenna is disposed at a focal point of the parabolic reflector. In some embodiments, the virtual surface comprises a spherical reflector, hyperbolic reflector, or a parabolic cylinder. In some embodiments, a radio is employed to transmit or receive and process signals from the feeding antenna. In some embodiments, a processor receives a processed signal from the radio or transmits a signal from the radio, and uses a beamforming algorithm to determine an optimal phase state across all reflectors in the phase-reconfigurable reflectarray, such that the optimal phase state beamforms energy from the phase-reconfigurable reflectarray to focus on desired targets and to suppress unwanted interfering signals. In some embodiments, the microwave circuit comprises an attenuator. In some embodiments, the fixed time delay element is disposed between the antenna element and the electronically controllable phase shifter. In certain embodiments, the electronically controllable phase shifter reflects signals back to the antenna element through the fixed time delay element.

According to another embodiment, an apparatus is disclosed. The apparatus comprises a plurality of the phase-reconfigurable reflectarrays described above, wherein the plurality of the phase-reconfigurable reflectarrays are arranged adjacent to one another and angularly offset from each other; and wherein a time delay associated with each fixed time delay element in each phase-reconfigurable reflectarray element is selected such that the plurality of phase-reconfigurable reflectarrays form one large virtual parabolic surface.

According to another embodiment, a phase-reconfigurable reflectarray or reconfigurable intelligent surface (RIS) is disclosed. The phase-reconfigurable reflectarray or RIS comprises a plurality of phase-reconfigurable reflectarray elements to transmit or receive radio signals disposed on a planar surface; wherein each phase-reconfigurable reflectarray element has an associated fixed time delay and an electronically controllable phase shifter. In some embodiments, the associated fixed time delay is achieved by a stack of antennas having different geometries. In some embodiments, the associated fixed time delay is achieved using a dielectric lens or a meta-surface lens applied to a feeding antenna. In some embodiments, the associated fixed time delay is achieved using a slow wave transmission line. In some embodiments, the associated fixed time delay is achieved using a conventional transmission line or guided wave structure.

### BRIEF DESCRIPTION OF THE DRAWINGS

For a better understanding of the present disclosure, reference is made to the accompanying drawings, in which like elements are referenced with like numerals, and in which:

FIG. 1 illustrates an embodiment of a radio system that includes the phase-reconfigurable reflectarray of the present disclosure;

FIG. 2 is a representation of a parabolic surface with the planar reflectarray superimposed on the parabolic surface;

FIG. 3 shows the resulting distance difference between the virtual parabolic surface and the planar reflectarray;

FIG. 4 illustrates the structure of each element in the reflectarray to achieve the desired virtual parabolic surface;

FIG. 5 shows the structure of the time delay element according to one embodiment;

FIG. 6 shows the structure of the phase shifter according to one embodiment;

FIG. 7 shows a cross-section of a printed circuit board, showing the use of the various layers according to one embodiment;

FIG. 8 shows a conventional reconfigurable reflectarray response after pointing/beamsteering towards a user and before and after beam adaptation to suppress interference;

FIG. 9 shows a reconfigurable reflectarray having a parabolic virtual surface after pointing/beamsteering towards a user and before and after beam adaptation to suppress interference; and

FIG. 10 shows a plurality of reflectarrays configured to create a large virtual parabolic surface.

### DETAILED DESCRIPTION

A new reflectarray or reconfigurable intelligent surface (RIS) is disclosed. The reflectarray or RIS includes reflectors that incorporate both a true time delay to define a virtual surface, as well as means for electronic reconfigurability of phase shift, such that energy incident on the reflectarray can be beamformed to amplify signals in one or more directions and suppress undesired signals in one or more directions.

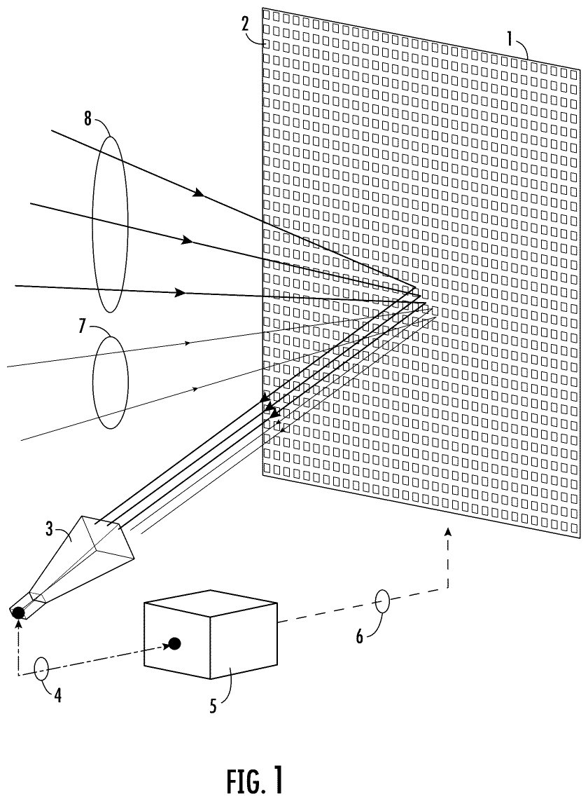

FIG. 1 shows the disclosed system according to one embodiment. In this embodiment, the system includes a phase-reconfigurable reflectarray 1 having a plurality of reconfigurable reflector elements, or reflectors 2. Signals are reflected toward a feeding antenna 3. The aggregated analog signal travels from the feeding antenna 3 to the radio 5 via a radio signal transmission line 4. The radio 5 then controls the phase-reconfigurable reflectarray 1 using control line 6. Also included in this figure are the arrival vectors 7 for a multiplicity of desired radio signals' wavefronts and the arrival vectors 8 for a multiplicity of undesired radio signals' wavefronts.

Each component is now described in more detail.

As best seen in FIG. 1, the phase-reconfigurable reflectarray 1 comprises a plurality of phase-reconfigurable reflector elements (also referred to as reflectors 2) arranged on a two-dimensional planar surface, such as a rectangular plane. The reflectors 2 may incorporate patch antennas. Alternatively, the reflectors 2 may include any radiating element, such as fractal, bowtie, or spiral antennas, or open-ended waveguides. The reflectors 2 may be narrow-band, multi-band, or broad-band, and may be linearly, circularly, or elliptically polarized. The reflectors 2 may also include a composite structure of similar or dissimilar elements, for example, a stack of patch antennas. The number of reflectors 2 in the array is not limited and may be over one thousand. For example, in FIG. 1, the reflectarray is configured as an array having 32 rows and 32 columns. Each reflector 2 may assume one of a plurality of phase-shift states.

As noted above, the phase-shift state of the reflectors 2 may be configured at any time by the radio 5 using the control line 6. In some embodiments, each reflector 2 may be individually selected, while in other embodiments, a row or column of reflectors 2 is addressed at one time. Note that the control line 6 may be either a cable or a wireless connection.

Thus, radio signals received from the environment around the system that are incident on a reflector 2 are reflected towards the feeding antenna 3. Radio signals transmitted from the feeding antenna 3 that are incident on a reflector 2 are reflected into the environment around the system.

A reflector's reflected radio signal is phase-shifted with respect to the phase of the incident radio signal on that reflector 2. Consequently, a reflected radio signal's phase-shift is dependent on the phase-shift state of the reflector 2. Additionally a reflector's reflected radio signal is time delayed with respect to the incident radio signal on that reflector 2. The amount of time delay is dependent on the position of the reflector 2 in the reflectarray 1.

Also note that the reflectors 2 may be resonant at the same radio frequency bands and polarizations as the feeding antenna 3.

The feeding antenna 3 may be mechanically positioned so that some set of the main or primary lobes from its gain pattern (the angular region of greatest sensitivity) cover some or all of the phase-reconfigurable reflectarray's reflectors 2. Radio signals from the phase-reconfigurable reflectarray 1 that are incident on the feeding antenna 3 are conveyed to the radio 5 via a radio signal transmission line 4, which may be a cable or waveguide. Radio signals transmitted from the radio 5 to the feeding antenna 3 via the radio signal transmission line 4 are radiated toward the phase-reconfigurable reflectarray 1. In some embodiments, the feeding antenna 3 is implemented to have a non-steerable directional pattern. In other embodiments, the feeding antenna 3 is implemented to have a steerable directional gain pattern where the steering is realized either by electronic or mechanical means. An example of electronic means may be to use a phased array as the feeding antenna 3. Steering of the gain pattern of the feeding antenna 3 changes the energy contribution across reflectors 2 in the reflectarray which in turn changes the directionality and sidelobe levels of the reflectarray's gain pattern.

As noted above, the feeding antenna 3 is connected to the radio 5 that converts between a radio frequency signal and a baseband signal which can be sampled by a processor or computer. Either using information received from this radio 5 or using prior knowledge of a target or interferer, an array beamforming algorithm executed by the processor can be used to determine an optimal phase state across each reflector 2 of the reconfigurable reflectarray 1 to both beamform energy reflected from the array of electronically controllable reflectors to be focused on desired targets and to suppress unwanted interfering signals. This desired array state is then communicated to and loaded onto the reconfigurable reflectarray 1.

In some embodiments, the radio system is configured such that the feeding antenna 3 and radio 5 are co-located on the same vehicle, platform, or structure as the phase-reconfigurable reflectarray 1. In other embodiments, the feeding antenna 3 and radio 5 are located on different vehicles, platforms, or structures from the phase-reconfigurable reflectarray 1.

The associated radio 5 may have one or both of a transmit and/or a receive mode, and may be used for sensing/RADAR, direction finding, or communications. In the case of a RIS, energy is incident from some distant, and possibly not fixed in location, source, and is beamformed by the array to focus the reflected energy on some other distant, and also possibly not fixed in location, target.

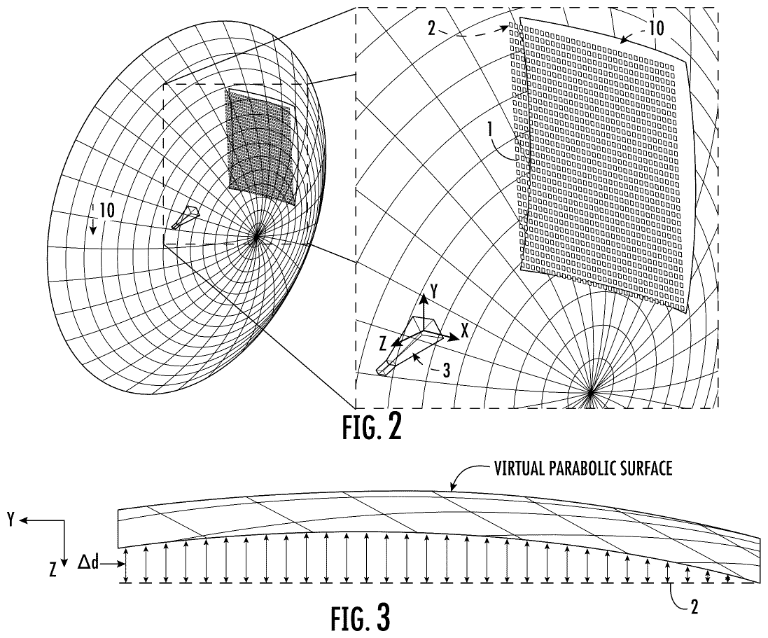

As noted above, the reflectarray 1 is constructed as a planar surface. However, as shown in FIG. 2, it may be advantageous to utilize a reflectarray having a curved surface, such as a parabolic surface 10. The insert in FIG. 2 shows the planar reflectarray projected onto a virtual parabolic surface. Note that the distance between each reflector 2 in the planar reflectarray and the parabolic surface varies as a function of the position in the (x, y) dimension. FIG. 3 shows a planar view of the distance from reflectors 2 in the planar reflectarray to the parabolic surface along the y direction. Note that each of these distances may be expressed as a time delay, where the time delay is equal to the distance divided by the speed of light.

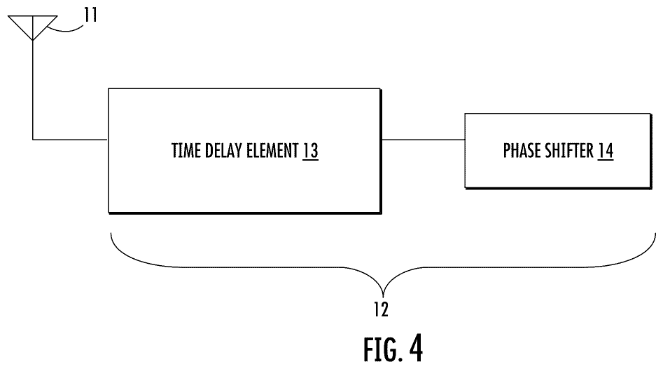

Each reflector 2 of the reflectarray 1 is designed such that the reflectarray 1 achieves this virtual parabolic surface. Specifically, FIG. 4 shows the structure of each reflector 2. Each reflector 2 includes an antenna element 11 that is in communication with a reflecting microwave circuit 12. As described above, the antenna element 11 may be any type of radiating element, such as a patch antenna, a fractal antenna, a bowtie antenna, a spiral antenna, or open-ended waveguides. The antenna elements 11 may be linearly, circularly, or elliptically polarized. The microwave circuit 12 includes a fixed time delay element 13 and an electronically controllable phase shifter 14. The output from the phase shifter 14 is then reflected back through the fixed time delay element 13 and to the antenna element 11. In another embodiment, the output from the phase shifter 14 may be supplied as a feed directly to the antenna element 11.

The fixed time delay element 13 of each reflector 2 is individually configured to be equal to the time delay necessary at that location in the (x, y) dimension to achieve the desired parabolic surface, as suggested in FIG. 3. Note that while FIG. 4 shows the output of the fixed time delay element 13 being supplied as the input to the phase shifter 14, the sequence of these components may be reversed such that the output from the phase shifter 14 feeds the fixed time delay element 13.

In some embodiments, a variable attenuator may be incorporated into each reflector 2, in addition to the phase shifter 14 and fixed time delay element 13 that defines the virtual surface. This may be a simple switched matched load to minimize any reflection from an individual reflector 2, or a variable attenuator to further shape a resulting beam formed by the reflectarray. Attenuators may serve several purposes. First, these attenuators may be used to attenuate or taper what is radiated from reflectors 2 close to the edge of the reflectarray 1 to shape the beam and reduce side lobes. Secondly, there are instances (such as calibration) where one or more reflectors are turned off such that when energy is incident of these reflectors, there is no reflection. Thus, in some embodiments, the attenuators are able to change the state of a reflector 2 to a completely “off” state”

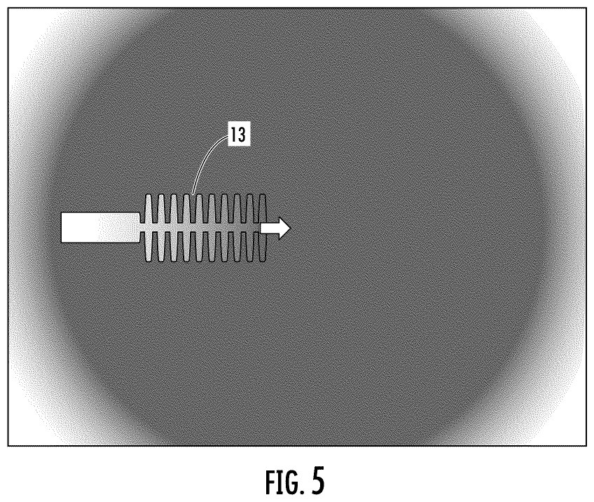

FIG. 5 shows the structure of the fixed time delay element 13 according to one embodiment. This structure is referred to as a slow wave transmission line. Slow wave transmission lines may be fabricated in many ways, many of which behave like alternating inductive and capacitive microwave elements in a periodic structure. In this figure, the particular structure comprises a conductive trace, such as a metal, that is formed having adjacent wide and narrow portions. The wide portions act as shunt capacitors while the narrow portions act as series inductors. By repeating this pattern a variable number of times, and by controlling the width of the wide portions, the delay associated with each fixed time delay element 13 may be controlled. In this way, the time delay associated with each reflector 2 may be individually configured such that the time delay is fixed for each reflector 2, but is variable from reflector to reflector such that across the reflectarray 1, a virtual parabolic reflector is formed. The fixed time delay element 13 may provide delays which may range from very small phase shifts to phase shifts that are many times that which the phase shifter 14 provides. Specifically, the time delay may be sufficiently long such that the phase wraps multiple times in the fixed time delay element 13 rather than being restricted to a single phase wrap (as is done with the phase shifter 14). For reflectors 2 in which available space for implementing a fixed time delay element 13 is limited by the size of the unit cell, which will generally be on the order of one half of a wavelength at the center frequency of operation, and assuming a single routing layer in a printed circuit board comprising the unit cell, the largest time delay achievable may be on the order of twenty times the wave period in free space with high dielectric constant materials and using slow-wave structures. Larger delays may be achievable with reflectors mounted in such a way that space perpendicular to the reflectarray panel may be used, or with many layer printed circuit boards. For example, if desired, two routing layers may produce a delay that may be on the order of forty times the wave period in free space. Further, the delay associated with each fixed time delay element 13 is determined solely based on its spatial position (i.e. the (x, y) position) in the reflectarray. In contrast, the delay associated with the phase shifter 14 is based on the frequency of the signal being received or transmitted, as well as the location of the desired and interfering signals. A “virtual parabolic surface” denotes that, in the absence of any phase shifts, the response from the planar reflectarray is similar to that of a parabolic reflector.

The time delay for each reflector 2 may be selected such that the focal point of the virtual parabolic reflector would be placed at the phase center of the feeding antenna 3. That is, for the choice of a parabolic virtual surface with a focal point at the feed point, if all phase shifters are set to the same state, a beam will be steered along the vector from the parabolic surface's apex to its focal point as in a conventional parabolic reflector dish antenna. In this way, for a fixed phase state across all reflectors 2, the response of the array is limited in frequency only by the bandwidth of the individual elements (the feeding antenna 3, and the reflectors 2) since the physical distance between a parabolic surface and its focal point is frequency agnostic, whereas in a conventional (flat panel) reconfigurable reflectarray or RIS, there is the additional frequency limitation due to the non-constant time delay from the feeding antenna 3 to each element which leads to a phase change across the panel that is not constant with frequency.

Note that while parabolic surfaces are described, the fixed time delay elements 13 may be configured to achieve any desired shape such as a parabolic reflector, a spherical reflector, hyperbolic reflector, or a parabolic cylinder. Thus, the use of the fixed time delay elements 13 allows the creation of a virtual surface, different from the planar surface of the reflectarray 1.

Of course, the fixed time delay element 13 may be created using different techniques. For example, the fixed time delay element 13 may simply be a conventional transmission line (in the form of a long trace of the printed circuit board, that is, a microstrip or stripline structure) that achieves the desired delay or may be another guided wave structure. Guided wave structures include transmission line geometries such as microstrips or striplines, as well as rectangular waveguides or similar structures such as substrate integrated waveguides, as well as dielectric waveguides. Alternatively, the antenna element 11 itself may be used to create the fixed time delay. For example, antennas of different geometries may be stacked to achieve the desired fixed time delay. For example, a stacked antenna may have a geometry that creates an adjustable group delay reflector to reflector. In another embodiment, a dielectric lens may be disposed on the feed itself. The lens may be a dielectric lens or a meta-surface lens and may be applied to a feeding antenna 3, such that at the point of the feeding antenna 3, the electrical distance from that feeding antenna is the same as some desired virtual surface. In this embodiment, the same mechanism in the lens that is used to bend electromagnetic waves would be used to synthesize a physical time delay.

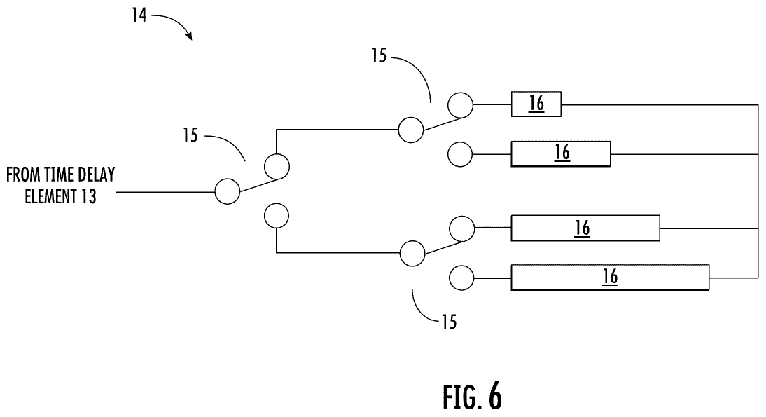

FIG. 6 shows a phase shifter 14 according to one embodiment. In this embodiment, a plurality of switches 15 are used to select one of a plurality of different phase shifts 16. These phase shifts 16 may be transmissive or reflective. In other words, if the energy passes from the antenna element 11 through the fixed time delay element 13 to the phase shifter 14 and then reflects back through the fixed time delay element 13 to the antenna element, the phase shifts are reflective. If the output of the phase shifter 14 is in direct contact with the antenna element 11, the phase shifts are transmissive. In some embodiments, such as that shown in FIG. 6, there may be 4 discrete phase-shift states. These may be used to create phase shifts of 0°, 90°, 180° and 270°. In other embodiments, there may be more or less than 4 discrete phase-shift states. In some embodiments, each reflector 2 may employ an electronic switching technology, such as Field Effect Transistor (FET) switches, varactor diodes, MEMS switches, or other suitable devices, to achieve different phase-shift states by switching between several RF structures or devices to achieve a desired phase state. These RF structures or devices may be transmission line stubs or reactive components or filters. For example, switched line phase shifters, also known as delay lines, may be used. Alternatively, switched filters, which use lumped elements (such as T or pi filters) or distributed elements (such as transmission lines) may be used to create the phase shifts 16. In other embodiments, each reflector 2 may employ a functional material, such as liquid crystal or graphene to achieve different phase-shift states. In yet other embodiments, the reflectors 2 may utilize a continuous set of phase-shift states using PIN diodes or ferroelectric materials. By varying the voltage applied to a ferroelectric material, a continuous set of phase-shift states may be achieved.

Note that unlike fixed time delay elements 13, which are frequency agnostic, the phase shifters 14 are generally specific to a particular center frequency.

Note that attenuation may be added to the phase shifter 14 in some embodiments. As an example, a resistor may be added to the plurality of phase shift states, or may replace one of the phase shifts 16. The resistor is used to absorb at least some of the power that is incident on the corresponding reflector 2.

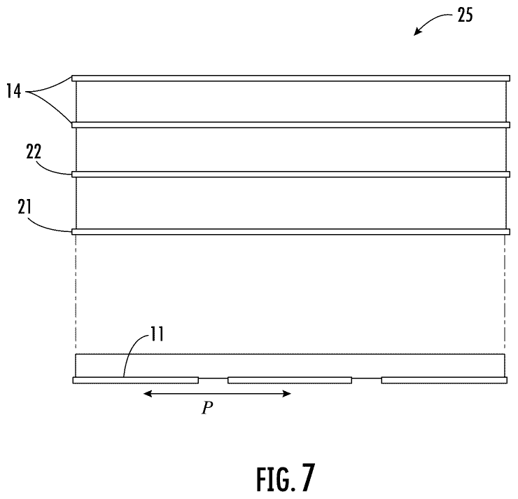

FIG. 7 shows the cross-section of the printed circuit board 25 used to create the reflectarray 1 according to one embodiment. The outer exposed surface of the printed circuit board may be used to form the antenna elements 11. These may be copper patch antennas in some embodiments. An adjacent layer may be used as the slot feed layer 21, which is used to connect to the various antenna elements 11. An entire layer, such as the slow-wave transmission line layer 22, may be used to create the fixed time delay elements 13 for each reflector 2. One or more routing layers may then exist for the phase shifters 14.

Thus, the incident signal on the antenna element 11 is both time delayed and phase shifted before being reflected back to the environment or the feeding antenna 3. In this way, improved performance may be achieved.

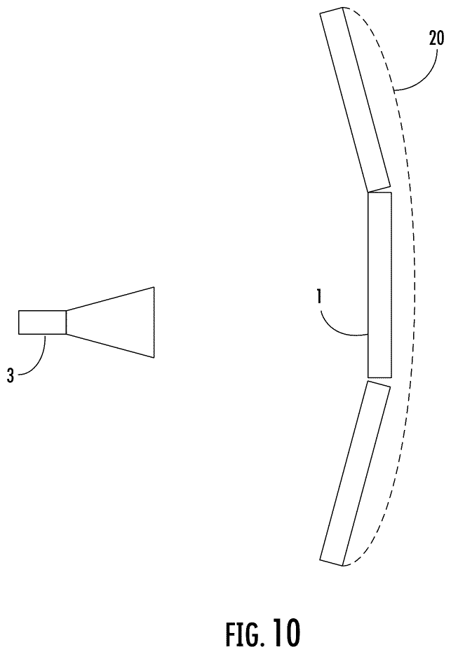

Note that multiple planar reflectarrays may be arranged to create a larger parabolic surface. For example, the reflectarrays may be configured at slight angles relative to each other, as shown in FIG. 10. The fixed time delay elements 13 for the various reflectors 2 in the different reflectarrays are configured to create a large combined virtual parabolic surface 20.

In addition to application for radio communication on a satellite, the disclosed system may be applied to:
Satcom links using radio terminals that operate in the presence of radio interference. Examples include gateway terminals, space terminals, marine terminals, airborne terminals, and ground terminals.
Terrestrial and airborne radio communication links that operate in the presence of radio interference. Examples include use at each end of a point-to-point wireless backhaul link for cellular and other terrestrial radio network.
Radar platforms operating in the presence of radio interference. An example includes a radar operating in the same band as nearby cellular base stations.
Terrestrial, airborne, and space-based radio sensing platforms operating in the presence of radio interference. An example includes a space-based weather sensor operating in the presence of ground-based man-made interference sources.
Anti-jam communications satellites, anti-jam terrestrial communications radios, and anti-jam airborne communication radios.

The present system has many advantages over prior art for reconfigurable reflectarrays that do not incorporate true time delays in their implementation. In some prior art literature, the argument has been made that true time delay is not necessary for wide bandwidth performance. Unexpectedly, analysis leading to the claimed invention demonstrates that including a true time delay has a large impact on the bandwidth of nulls, an analysis which has not previously been performed on conventional reconfigurable reflectarrays with only phase reconfigurability. This is a critical point for systems which must operate in the presence of interference. This is an increasingly common scenario in commercial applications both with the proliferation of commercial satellite communications, and the proliferation of the high bandwidth demands of 5G and 6G+ communication terrestrially. For defense applications, this scenario has always been of interest. The following figures demonstrate this impact on the bandwidth of nulls.

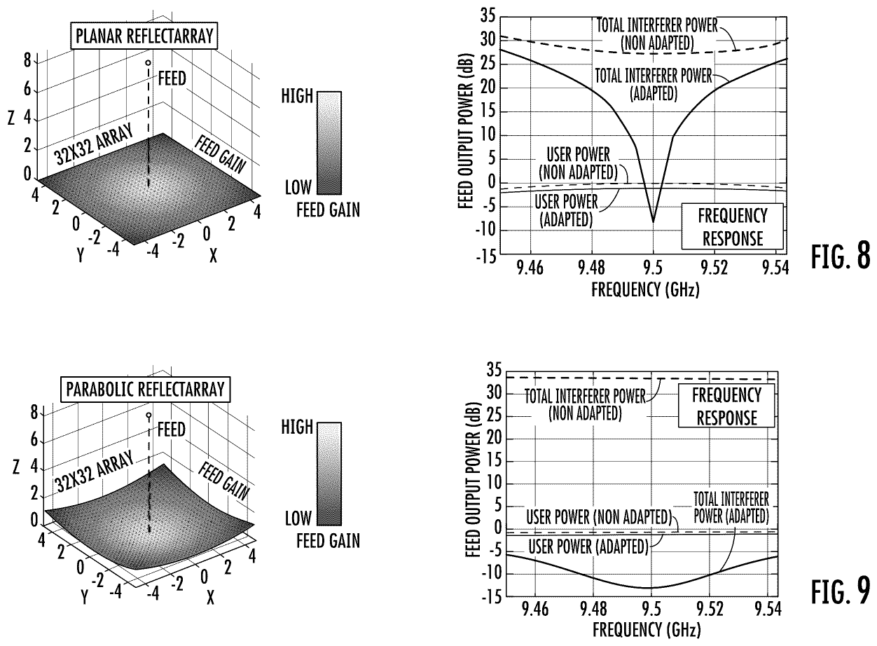

FIG. 8 shows the response of a traditional planar reconfigurable reflectarray in the presence of an interferer signal. The non-adapted signals show the power of the interferer signal and the user signal before any beam steering algorithm is performed. The adapted signals show the power associated with these same signals after beam steering, that is, optimizing the phase states on all the reflectors to maximize gain towards a user and minimize gain towards an interferer. Note that the power of the interferer signal is reduced by about 35 dB at the frequency of 9.5 GHz. However, the suppression is less as one moves away from 9.5 GHz. For example, the suppression is less than 10 dB at 9.48GHz. The bandwidth, or the frequency range where an interference signal is below a target power level, or resultant in a target user signal power to interference power ratio, of “Total Interferer Power (adapted)” is a measure of nulling bandwidth. Thus, the nulling bandwidth shown in FIG. 8 is relatively small. A target interference signal power suppression or effective ratio of signal to interference plus noise after adaptation will be application specific and depend on the use case and specific waveform used as well as the capabilities of radios in use in a system or communication link. The frequency range over which the target interference signal power suppression is achieved is closely tied to the bandwidth of a null in a radiation pattern (defined by a collection of reflectarray element phase states) which is the frequency range over which directed energy at the array from a particular direction or angle relative to the array stays below a target value or changes a specified amount from the maximum point of suppression, for example, a 3 dB change.

FIG. 9 shows the response of the disclosed reconfigurable reflectarray having a virtual parabolic surface. The disclosed reconfigurable reflectarray having the virtual parabolic surface includes a processor that uses a beamforming algorithm to determine an optimal phase state across all reflectors 2 the reflectarray 1, such that this optimal phase state beamforms energy from the reflectarray 1 to focus on desired targets and to suppress unwanted interfering signals.

Note that the same user and interferer signals are used. However, the new reflectarray is able to suppress the interferer signal by more than 35 dB over a frequency range of at least 100 MHz. The bandwidth of “Total Interferer Power (adapted)”, which also represents the signal to interference plus noise ratio (SINR) is a measure of nulling bandwidth and is much wider than the planar reconfigurable reflectarray shown in FIG. 8. The bandwidth of “Total Interferer Power (adapted)” is able to be much wider in this instance by a factor of more than twenty times in terms of fractional bandwidth because of the time delay elements, which synthesize a virtual parabolic surface that removes the restriction on bandwidth from the delay spread between the feed antenna and the individual unit cells on a reflectarray panel. That is, the location of nulls do not change as fast as a function of frequency when a parabolic virtual surface is applied resulting in a more stable, with respect to frequency, null in the adapted beam pattern.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A phase-reconfigurable reflectarray or reconfigurable intelligent surface (RIS), comprising:
a plurality of phase-reconfigurable reflectarray elements to transmit or receive radio signals disposed on a planar surface;
wherein each phase-reconfigurable reflectarray element comprises:
an antenna element that feeds a microwave circuit;
wherein the microwave circuit comprises a fixed time delay element in series with an electronically controllable phase shifter.

2. The phase-reconfigurable reflectarray or RIS of claim 1, wherein the fixed time delay element is fixed for each reflectarray element and is variable across the phase-reconfigurable reflectarray or RIS.

3. The phase-reconfigurable reflectarray or RIS of claim 2, wherein a delay of the fixed time delay element is determined based on a spatial position of the reflectarray element in the phase-reconfigurable reflectarray.

4. The phase-reconfigurable reflectarray or RIS of claim 3, wherein the delay ranges from 0 to twenty phase wraps of a center frequency.

5. The phase-reconfigurable reflectarray or RIS of claim 1, wherein the fixed time delay element is formed from a slow wave transmission line.

6. The phase-reconfigurable reflectarray or RIS of claim 1, wherein a delay associated with each fixed time delay element is configured to create a virtual surface.

7. The phase-reconfigurable reflectarray or RIS of claim 6, wherein the virtual surface comprises a parabolic reflector.

8. The phase-reconfigurable reflectarray or RIS of claim 7, further comprising a feeding antenna disposed at a focal point of the parabolic reflector.

9. The phase-reconfigurable reflectarray or RIS of claim 6, wherein the virtual surface comprises a spherical reflector, hyperbolic reflector, or a parabolic cylinder.

10. The phase-reconfigurable reflectarray or RIS of claim 8, further comprising a radio to transmit or receive and process signals from the feeding antenna.

11. The phase-reconfigurable reflectarray or RIS of claim 10, further comprising a processor, wherein processor receives a processed signal from the radio or transmits a signal from the radio, and uses a beamforming algorithm to determine an optimal phase state across all reflectors in the phase-reconfigurable reflectarray, such that the optimal phase state beamforms energy from the phase-reconfigurable reflectarray to focus on desired targets and to suppress unwanted interfering signals.

12. The phase-reconfigurable reflectarray or RIS of claim 1, wherein the microwave circuit comprises an attenuator.

13. The phase-reconfigurable reflectarray or RIS of claim 1, wherein the fixed time delay element is disposed between the antenna element and the electronically controllable phase shifter.

14. The phase-reconfigurable reflectarray or RIS of claim 13, wherein the electronically controllable phase shifter reflects signals back to the antenna element through the fixed time delay element.

15. An apparatus, comprising:
a plurality of the phase-reconfigurable reflectarrays of claim 1,
wherein the plurality of the phase-reconfigurable reflectarrays are arranged adjacent to one another and angularly offset from each other;
and wherein a time delay associated with each fixed time delay element in each phase-reconfigurable reflectarray element is selected such that the plurality of phase-reconfigurable reflectarrays form one large virtual parabolic surface.

16. A phase-reconfigurable reflectarray or reconfigurable intelligent surface (RIS), comprising:
a plurality of phase-reconfigurable reflectarray elements to transmit or receive radio signals disposed on a planar surface;
wherein each phase-reconfigurable reflectarray element has an associated fixed time delay and an electronically controllable phase shifter.

17. The phase-reconfigurable reflectarray or RIS of claim 16, wherein the associated fixed time delay is achieved by a stack of antennas having different geometries.

18. The phase-reconfigurable reflectarray or RIS of claim 16, wherein the associated fixed time delay is achieved using a dielectric lens or a meta-surface lens applied to a feeding antenna.

19. The phase-reconfigurable reflectarray or RIS of claim 16, wherein the associated fixed time delay is achieved using a slow wave transmission line.

20. The phase-reconfigurable reflectarray or RIS of claim 16, wherein the associated fixed time delay is achieved using a conventional transmission line or guided wave structure.
